(19) United States
(12) Patent Application Publication
(10) Pub. No.: US 2025/0028086 A1
(43) Pub. Date: Jan. 23, 2025

(54) LENS ASSEMBLY AND PROCESSING METHOD OF LENS ASSEMBLY

(71) Applicants: Asphetek Solution (Chengdu) Ltd., Chengdu (CN); Asphetek Solution Inc., Hsinchu (TW)

(72) Inventor: CHEN-CHU HSU, Hsinchu (TW)

(21) Appl. No.: 18/508,911

(22) Filed: Nov. 14, 2023

(30) Foreign Application Priority Data
Jul. 17, 2023 (CN) 202321876240.9

(51) Int. Cl. G02B 3/00

(52) U.S. Cl. CPC G02B 3/00; G02B 2003/0093

(57) ABSTRACT

A lens assembly is provided, comprising a first lens, a second lens, a limiting component, a positioning component, and a connecting component. The first lens is stacked with the second lens. The limiting component comprises a first limiting piece and a second limiting piece, a receiving groove is formed between the first limiting piece and the second limiting piece. The positioning component comprises a positioning bulge, the positioning bulge is arranged on a side of the second lens near the first lens. The connecting component comprises a first connecting structure and a second connecting structure, the first connecting structure is arranged on the first lens, the second connecting structure is arranged on the second lens, the second connecting structure is bonded with the first connecting structure.

### FIELD

The present disclosure relates to field of optical device technology, particularly to a lens assembly and a processing method of a lens assembly.

### BACKGROUND

Most optical devices, such as virtual reality (VR) glasses, include an optical module, the optical module includes at least two lenses to construct an optical path. When two or more lenses are installed, lenses need to be aligned, fitted, and supported by additional auxiliary support structures. The additional auxiliary support structures have dimensional tolerances and subsequent assembly tolerances. After the installation of the optical module, the above-mentioned tolerances can easily cause dislocation, deviation and tilt of the surface shape and optical axis of the lenses, resulting deviations of the optical path. Such deviations may affect the quality of VR imaging.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a schematic view of a lens assembly in a first embodiment of the present disclosure.

FIG. 2 illustrates a cross sectional, exploded view of the lens assembly in FIG. 1.

FIG. 3 illustrates a cross sectional view of the lens assembly in FIG. 1.

FIG. 4 illustrates another cross-sectional view of the lens assembly in FIG. 1.

FIG. 5 illustrates a cross sectional view of the lens assembly in a second embodiment of the present disclosure.

FIG. 6 illustrates another cross-sectional view of the lens assembly in FIG. 5.

FIG. 7 illustrates yet another cross-sectional view of the lens assembly in FIG. 5.

FIG. 8 illustrates a cross sectional view of the lens assembly in a third embodiment of the present disclosure.

FIG. 9 illustrates a flow diagram of an embodiment of the processing method of the lens assembly according to the present disclosure.

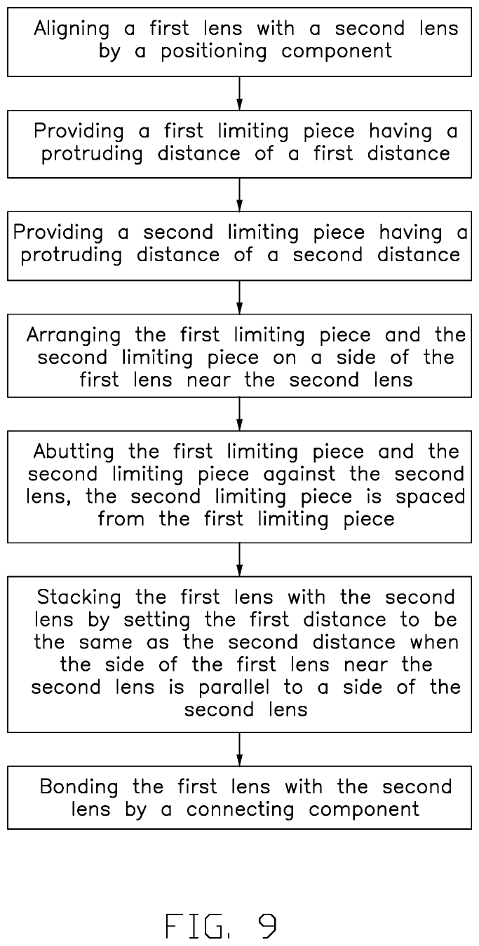

### DETAILED DESCRIPTION

In order to make the above-mentioned objects, features and advantages of the present application more obvious, a detailed description of specific embodiments of the present application will be described in detail with reference to the accompanying drawings. A number of details are set forth in the following description so as to fully understand the present application. However, the present application can be implemented in many other ways different from those described herein, and those skilled in the art can make similar improvements without violating the contents of the present application. Therefore, the present application is not to be considered as limiting the scope of the embodiments described herein.

Several definitions that apply throughout this disclosure will now be presented.

The term “coupled” is defined as coupled, whether directly or indirectly through intervening components, and is not necessarily limited to physical connections. The connection may be such that the objects are permanently coupled or releasably coupled. The term “substantially” is defined to be essentially conforming to the particular dimension, shape, or other feature that the term modifies, such that the component need not have that exact feature. The term “comprising,” when utilized, means “including, but not necessarily limited to”; it specifically indicates open-ended inclusion or membership in the so-described combination, group, series, and the like.

Unless otherwise defined, all technical and scientific terms used herein have the same meaning as commonly understood by one skilled in the art. The terms used in a specification of the present application herein are only for describing specific embodiments and are not intended to limit the present application. The terms “and/or” used herein comprises any and all combinations of one or more of associated listed items.

Some embodiments of the present application are described in detail. In the case of no conflict, the following embodiments and the features in the embodiments can be combined with each other.

A first embodiment:

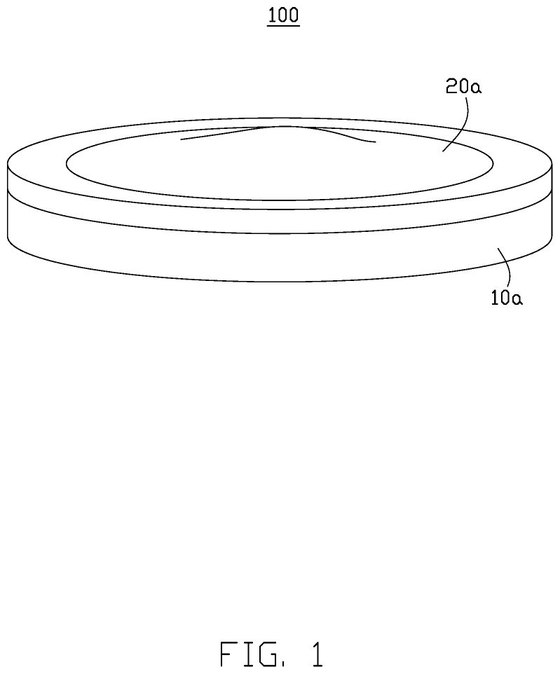

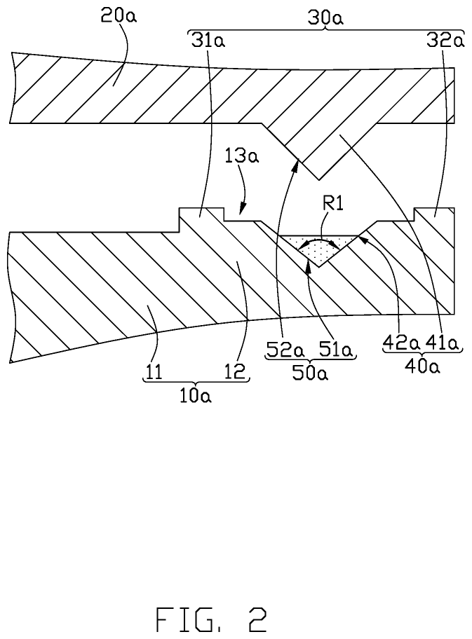

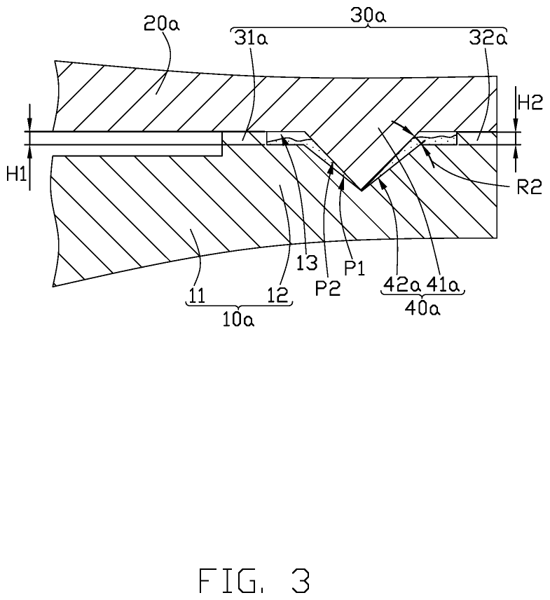

Referring to FIG. 1, FIG. 2, and FIG. 3, the first embodiment of the present application discloses a lens assembly 100. The lens assembly 100 includes a first lens 10a, a second lens 20a, a limiting component 30a, a positioning component 40a, and a connecting component 50a. The first lens 10a is stacked with the second lens 20a. The limiting component 30a, the positioning component 40a and the connecting component 50a are arranged between the first lens 10a and the second lens 20a. The limiting component 30a, the positioning component 40a and the connecting component 50a are used to the positioning assembly of the first lens 10a and the second lens 20a.

In other embodiments, the lens assembly 100 may also include at least three lenses. The limiting component 30a, positioning component 40a and connecting component 50a can be provided between any two adjacent lenses. In one embodiment, the lens assembly 100 may also include at least three lens assemblies, each lens assembly includes at least two lenses.

The limiting component 30a includes a first limiting piece 31a and a second limiting piece 32a. The first limiting piece 31a and the second limiting piece 32a are arranged on a side of the first lens 10a near the second lens 20a. Each of the first limiting piece 31a and the second limiting piece 32a abuts against the second lens 20a. Therefore, the first lens 10a is stacked with the second lens 20a and positioned by the limiting component 30a. A mounting distance between the first lens 10a and the second lens 20a is limited by the first limiting piece 31a and the second limiting piece 32a. Therefore, a distance between the first lens 10a and the second lens 20a is fixed, the distance is the length of the in-plane optical path between the first lens 10a and the second lens 20a. In a radial direction of the first lens 10, the second limiting piece 32a is spaced from the first limiting piece 31a, the second limiting piece 32a is located outside the first limiting piece 31a. A receiving groove 13a is formed between the first limiting piece 31a and the second limiting piece 32a.

The positioning component 40a is provided with an adhesive material, the first lens 10a is boned to the second lens 20a by the adhesive material. When the first lens 10a is bonded with the second lens 20a, the receiving groove 13a is an overflow area of excess adhesive material. After the first lens 10a and the second lens 20a are bonded and the adhesive material is extruded, the excess adhesive material is spilled into the receiving groove 13a to avoid the adhesive material polluting the lens.

In one embodiment, the first limiting piece 31a and the second limiting piece 32a can be arranged on a side of the second lens 20a near the first lens 10a. In other embodiments, the first limiting piece 31a is arranged on the first lens 10a, the second limiting piece 32a is arranged on the second lens 20a. Alternatively, the first limiting piece 31a is arranged on the second lens 20a, the second limiting piece 32a is arranged on the first lens 10a.

The positioning component 40a includes one or more positioning bulge 41a. The positioning bulge 41a is arranged on the surface of the second lens 20a near the first lens 10a. The side of the first lens 10a near the second lens 20a is provided with a positioning groove 42a. The positioning bulge 41a is received in the positioning groove 42a. The first lens 10a is assembled with the second lens 20a by the positioning bulge 41a. After the first lens 10a and the second lens 20a are assembled by the positioning component 40a, the first limiting piece 31a and the second limiting piece 32a abut against the second lens 20a.

In other embodiments, the positioning bulge 41a can also be arranged on the first lens 10a, and the positioning groove 42a is arranged on the second lens 20a.

The connecting component 50a is received in the receiving groove 13a, the connecting component 50a includes a first connecting structure 51a and a second connecting structure 52a. The first connecting structure 51a is arranged on the first lens 10a. The second connecting structure 52a is arranged on the second lens 20a. The second connecting structure 52a is bonded with the first connecting structure 51a.

In other embodiments, the first connecting structure 51a is arranged on the second lens 20a, and the second connecting structure 52a is arranged on the first lens 10a.

The lens assembly 100 is provided with the limiting component 30a, the positioning component 40a and the connecting component 50a between the first lens 10a and the second lens 20a. After the first lens 10a is aligned with the second lens 20a through the positioning component 40a, the first lens 10a and the second lens 20a are stacked through the limiting component 30a. The first lens 10a abuts against the second lens 20a. The first lens 10a is fixed with the second lens 20a by the connecting component 50a. The limiting component 30a, the positioning component 40a and the connecting component 50a are arranged on the first lens 10a or the second lens 20a. Therefore, the first lens 10a can be connected to the second lens 20a. A dimensional tolerance and an assembly tolerance are not easy to be affected, and better imaging effect can be ensured by assembling the first lens 10a and the second lens 20a.

Referring to FIG. 2 and FIG. 3, in one embodiment, the first lens 10a can be circle, oval or irregular in shape, and so on. The first lens 10a includes a center portion 11 and an outer portion 12. The center portion 11 is an optical path area. The outer portion 12 is arranged on a periphery of the center portion 11, and the outer portion 12 is a non-optical path area. The center portion 11 and the outer portion 12 are integrally formed.

The first limiting piece 31a and the second limiting piece 32a are arranged in the outer portion 12. The first limiting piece 31a and the second limiting piece 32a are arranged in a ring structure. The first limiting piece 31a is arranged around an inner edge of the outer portion 12, the second limiting piece 32a is arranged around an outer edge of the outer portion 12.

In some embodiments, quantity of the first limiting pieces 31a is multiple. The first limiting pieces 31a are arranged at intervals, and each of the first limiting pieces 31a is arranged around the inner edge of the outer portion 12. Quantity of the second limiting pieces 32a is multiple, the second limiting pieces 32a is arranged at intervals. Each of the second limiting piece 32as is arranged around the outer edge of the outer portion 12.

Referring to FIG. 2 and FIG. 3, the first limiting piece 31a is protruded toward the second lens 20a from a side of the outer portion 12 near the second lens 20a. A protrusive distance of the first limiting piece 31a is a first distance H1. The second limiting piece 32a is protruded toward the second lens 20a from the side of the outer portion 12 near the second lens 20a. A protruding distance of the second limiting piece 32a is a second distance H2. When an adjacent sides of the first lens 10a and the second lens 20a are parallel, the second distance H2 is the same as the first distance H1. When the first lens 10a and the second lens 20a are assembled to form an optimal optical path, a distance between the first lens 10a and the second lens 20a is the same as the second distance H2.

In some embodiment, if one side of the first lens 10a and the second lens 20a is not parallel to the other side of the first lens 10a and the second lens 20a, the first distance H1 and the second distance H2 are different.

Referring to FIG. 2 and FIG. 3, the positioning bulge 41a is protruded outwards from the side of the second lens 20a near the first lens 10a, the positioning bulge 41a abuts against the outer portion 12 of the first lens 10a. The positioning bulge 41a is arranged in a circular structure to fit a shape of the second lens 20a. Therefore, after the first lens 10a is positioned with the second lens 20a, the first lens 10a is aligned with the center of the optical axis of t the second lens 20a. A cross section of positioning bulge 41a can be triangular, semicircular, or rectangular, etc.

A positioning groove 42a is arranged around a peripheral of the first limiting piece 31a. An opening of positioning groove 42a is defined toward the positioning bulge 41a. A shape of positioning groove 42a is consistent with a shape of the positioning bulge 41a. A dimension of the positioning bulge 41a is larger than a dimension of the positioning groove 42a, an end of the positioning bulge 41a facing the positioning groove 42a is received in the positioning groove 42a. When the second lens 20a abuts against the first limiting piece 31a, an end of the positioning bulge 41a away from the second lens 20a is extended into the positioning groove 42a, the positioning bulge 41a abuts against a bottom of the positioning groove 42a. Therefore, the first lens 10a and the second lens 20a are positioned. The first limiting piece 31a and the second limiting piece 32a make fixedly an optical distance between the first lens 10a and the second lens 20a, optical arises of the first lens 10a and the second lens 20a are aligned.

In some embodiments, a groove depth of the positioning groove 42a is not greater than half a thickness of the outer portion 12, a width of the positioning groove 42a is not greater than half a width of the outer portion 12.

In some embodiments, a cross section of the positioning groove 42a is a triangle. A first angle R1 is formed between two inner walls of the positioning groove 42a, and the first angle R1 is greater than 50°. If the first angle R1 is too small, a size of the first lens 10a injection molding and the stress during processing can be controlled.

Referring to FIG. 3, the first connecting structure 51a is an inner wall of positioning groove 42a, the inner wall of positioning groove 42a is the first connecting surface P1. The second connecting structure 52a is an outer wall of the positioning bulge 41a, the outer wall of the positioning bulge 41a is the second connection surface P2. A second angle R2 is formed between the first connecting surface P1 and the second connecting surface P2, the second angle R2 is 1° to 10°. A gap is formed between the first connecting surface P1 and the second connecting surface P2, the gap is filled with adhesive material. The adhesive material is liquid low-viscosity glue, liquid low-viscosity glue can be cured by UV curing, heat curing or natural curing.

Since an end of the positioning bulge 41a far from the second lens 20a is extended into the positioning groove 42a, the positioning bulge 41a abuts against a bottom of the positioning groove 42a. A bottom end of the first connecting surface P1 is intersected with a bottom end of the second connecting surface P2, a top end of the first connecting surface P1 and the second connecting surface P2 is defined with an opening. Therefore, the adhesive material in the gap can overflow from the opening into the receiving groove 13a. A section of the receiving groove 13a temporarily stores the adhesive material. The first limiting piece 31a and the second limiting piece 32a can block the adhesive material, the adhesive material is temporarily stored in the outer portion 12. The adhesive material is prevented from spilling outside the first lens 10a and the second lens 20a, an outside of the lens is prevented from getting contaminated. A volume of the receiving groove 13a is a maximum filling amount of adhesive material to avoid an overflow of the adhesive material.

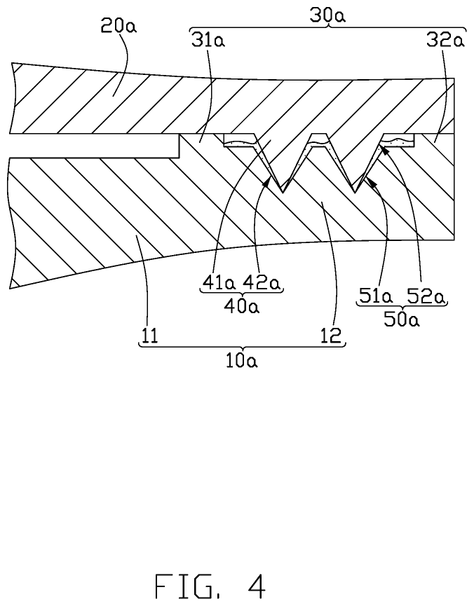

Referring to FIG. 4, quantity of the positioning component 40a can be two or more, each positioning component 40a has a same shape and different size. Therefore, each positioning component 40a is set apart from each other, the first lens 10a and the second lens 20a can be positioned through a joint action of each positioning component 40a. Several connecting components 50a is the same as several positioning components 40a.

A second embodiment:

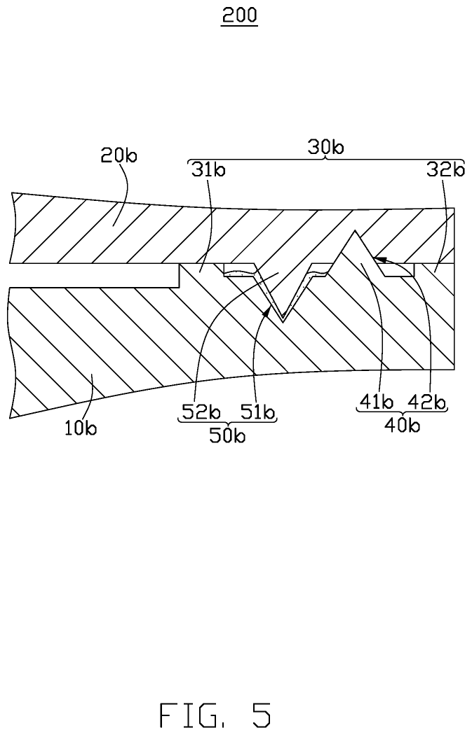

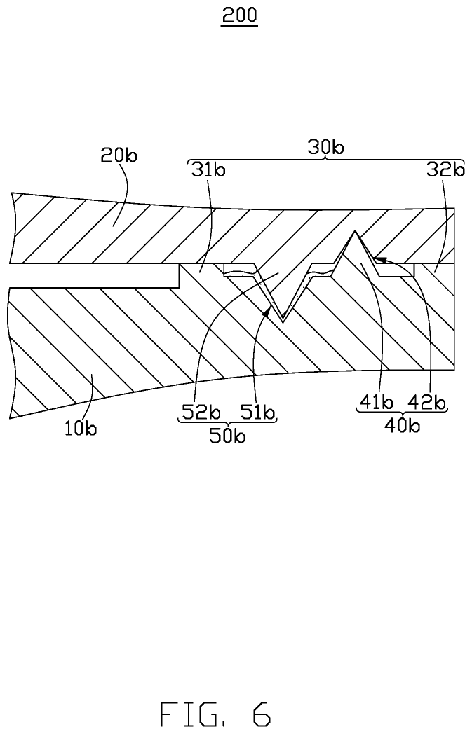

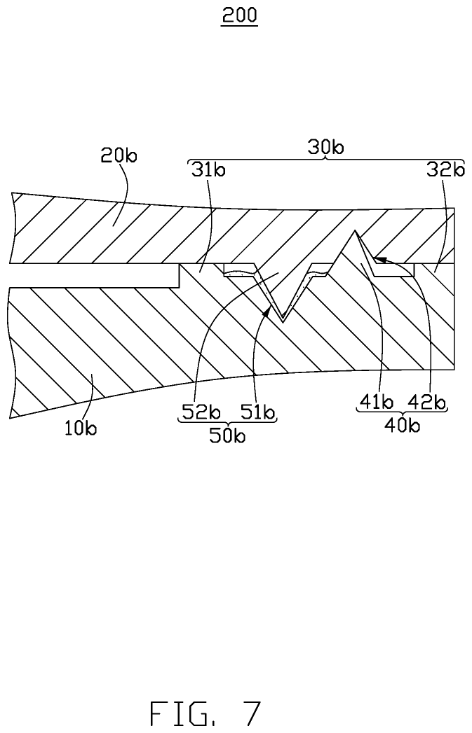

Referring to FIG. 5 to FIG. 7, a lens assembly 200 includes a limiting component 30b, a positioning component 40b, and a connecting component 50b. The positioning component 40b is arranged between a first limiting piece 31b and a second limiting piece 32b, and the positioning component 40b includes a positioning bulge 41b and a positioning groove 42b.

The positioning bulge 41b is arranged on a side of the first lens 10b near the second lens 20b, the positioning bulge 41b is arranged around a periphery of the first limiting piece 31b. The positioning groove 42b is defined on a surface of the second lens 20b near the first lens 10b. In other embodiments, the positioning groove 42b is defined on the side of the second lens 20b near the first lens 10b, and the positioning groove 42b is defined on the side of the first lens 10b near the second lens 20b.

In some embodiment, a shape of the positioning bulge 41b is same as a shape of the positioning groove 42b, and the positioning bulge 41b is partially received in the positioning groove 42b. A peripheral wall of the positioning bulge 41b contained in positioning groove 42b abuts against an inner peripheral wall of positioning groove 42b.

For example, a cross sections of the positioning bulge 41b and the positioning groove 42b is triangular. Two outer walls of the positioning bulge 41b are arranged parallel to two inner walls of the positioning groove 42b, and an inner wall of the positioning groove 42b abuts against an outer wall of the corresponding positioning bulge 41b.

In other embodiments, the shape of the positioning bulge 41b is different with the shape of the positioning groove 42b. To ensure a coordination between the positioning bulge 41b and the positioning groove 42b, the first lens 10b is positioned to the second lens 20b, a convex point of the positioning bulge 41b towards the positioning groove 42b abuts against a concave point of the positioning groove 42b towards the positioning bulge 41b. In another embodiments, a one outer wall of the positioning bulge 41b abuts against a one inner wall of the positioning groove 42b, another outer wall of the positioning bulge 41b is separated from another inner wall of the positioning groove 42b.

The connecting component 50b is arranged on one side of the positioning component 40b. The connecting component 50b is located between the first limiting piece 31b and the second limiting piece 32b. A first connecting structure 51b is concave inward from a bottom wall of the receiving groove 13b, and the first connecting structure 51b is arranged around a periphery of the first limiting piece 31b. A second connecting structure 52b is protruded outwards from an end of the second lens 20b near the first lens 10b, and the second connecting structure 52b is partially contained in the first connecting structure 51b.

A shape of second connecting structure 52b is matched with a shape of the first connecting structure 51b. When the second connecting structure 52b is extended into the first connecting structure 51b, an outer wall of the second connecting structure 52b is spaced from an outer wall of the first connecting structure 51b. A gap is formed between the first connecting structure 51b and the second connecting structure 52b. The gap is filled with adhesive material, the adhesive material can be evenly distributed between the first connecting structure 51b and the second connecting structure 52b. Therefore, a stability of the first lens 10b and the second lens 20b mounting can be improved.

The outer wall of the second connecting structure 52b and the inner wall of the first connecting structure 51b can be arranged parallel. In other embodiments, the outer wall of the second connecting structure 52b and the inner wall of the first connecting structure 51b can be tilted. The gap for adhesive material filling can be formed between the first connecting structure 51b and the second connecting structure 52b.

In one embodiment, except for the above structures, the other structures of the limiting component 30b, the positioning component 40b, and the connecting component 50b in the second embodiment are the same as structures and principles of the first embodiment.

A third embodiment:

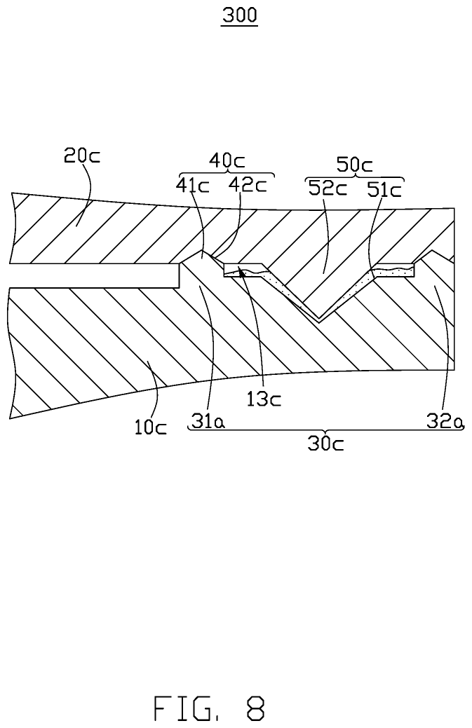

Referring to FIG. 8, the lens assembly 300 includes a limiting component 30c, a positioning component 40c, and a connecting component 50c. The positioning component 40c includes a positioning bulge 41c and a positioning groove 42c. The positioning protrusion 41c is protruded outwardly from the first limiting piece 31c and the second limiting piece 32c away from an end of the first lens 10c. The positioning groove 42c is indented from a surface of the second lens 20c near a side of the first lens 10c. The positioning bulge 41c is receiving in the positioning groove 42c.

In some embodiments, a shape and size of the positioning bulge 41c are the same as a shape and size of the positioning groove 42c. The positioning bulge 41c includes at least two outer walls. The positioning bulge 41c is received in the positioning groove 42c. Each outer wall of the positioning bulge 41c abuts against an inner wall of the positioning groove 42c, a gap is not existed between the positioning bulge 41c and the positioning groove 42c. An end face of the positioning bulge 41c near the first limiting piece 31c is located at the same height as a surface of the second lens 20c near the first lens 10c. After the first lens 10c is aligned with the second lens 20c, an installation spacing of the first lens 10c and the second lens 20c is determined by the limit component 30c, the installation spacing is not affected by positioning component 40c.

In some embodiments, shapes of the positioning bulge 41c and the positioning groove 42c can also be different. The first lens 10c is aligned with the second lens 20c by coordination between the positioning bulge 41c and the positioning groove 42c. A convex point of the positioning bulge 41c towards the positioning groove 42c abuts against a convex point of the positioning groove 42c towards the positioning bulge 41c. In other embodiments, an outer wall of the positioning bulge 41c abut against an inner wall of the positioning groove 42c, while the outer wall of the positioning bulge 41c is separated from the inner wall of the positioning groove 42c.

In other embodiments, the positioning groove 42c can be concaved inward from an end of the first limiting piece 31c and the second limiting piece 32c which the end is away from the first lens 10c. The positioning bulge 41c can be protruded outward from the surface of a side of the second lens 20c near the first lens 10c.

The connection component 50c is located between the first limiting piece 31c and the second limiting piece 32c. The first connecting structure 51c is indented from a bottom wall of the receiving groove 13c, and the first connecting structure 51c is arranged around a periphery of the first limiting piece 31c. The second connecting structure 52c is protruded outwardly from an end of the second lens 20c near the first lens 10c. The second connecting structure 52c is partially contained in the first connecting structure 51c. When the second connecting structure 52c is partially contained in the first connecting structure 51c, the gap is formed between the second connecting structure 52c and the first connecting structure 51c, the gap is filled with adhesive material.

In one embodiment, except for the above structures, the other structures of the limiting component 30c, the positioning component 40c, and the connecting component 50c in the third embodiment are the same as the structures and principles of the first embodiment.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A lens assembly comprising:
a first lens;
a second lens, wherein the first lens is stacked with the second lens;
a limiting component, comprising a first limiting piece and a second limiting piece, wherein the first limiting piece and the second limiting piece are arranged on a side of the first lens near the second lens, and each of the first limiting piece and the second limiting piece abuts against the second lens, the second limiting piece is spaced from the first limiting piece, a receiving groove is formed between the first limiting piece and the second limiting piece;
a positioning component, wherein the positioning component comprises a positioning bulge, the positioning bulge is arranged on a surface of the second lens near the first lens, a positioning groove is defined on a side of the first lens near the second lens, the positioning bulge is received in the positioning groove; and
a connecting component, wherein the connecting component is arranged in the receiving groove, the connecting component comprises a first connecting structure and a second connecting structure, the first connecting structure is arranged on the first lens, the second connecting structure is arranged on the second lens, the second connecting structure is bonded with the first connecting structure.

2. The lens assembly as claimed in claim 1, wherein the first limiting piece is protruded toward the second lens from the side of the first lens near the second lens, a protruding distance of the first limiting piece is a first distance, the second limiting piece is protruded toward the second lens from the side of the first lens near the second lens, a protruding distance of the second limiting piece is a second distance, the second distance is the same as the first distance.

3. The lens assembly as claimed in claim 1, wherein the first lens comprises a center portion and an outer portion, the outer portion is arranged on a periphery of the center portion, the first limiting piece and the second limiting piece are arranged on a side of an outer portion near the second lens, and the second limiting piece is arranged around an outer edge of the outer portion.

4. The lens assembly as claimed in claim 1, wherein the positioning groove is defined on a bottom wall of the receiving groove, the positioning groove is provided around a periphery of the first limiting piece, the positioning bulge is protruded outward from the surface of the second lens, the positioning bulge is partially received in the positioning groove, and the positioning bulge is away from an end of the second lens to abut against a bottom of the positioning groove.

5. The lens assembly as claimed in claim 4, wherein the first connecting structure is an inner wall of the positioning groove, the second connecting structure is an outer wall of the positioning bulge, the first connecting structure is spaced from the second connecting structure, a gap is formed between the first connecting structure and the second connecting structure, and the gap is configured to be in filled with an adhesive material.

6. The lens assembly as claimed in claim 4, wherein the connecting component is arranged on one side of the positioning component, the first connecting structure is concaved from a bottom wall of the receiving groove, the first connecting structure is arranged around the periphery of the first limiting piece, the second connecting structure is protruded outward from the end of the second lens close to the first lens, and the second connecting structure is partially contained in the first connecting structure.

7. The lens assembly as claimed in claim 6, wherein an outer wall of the second connecting structure is at least partially spaced from an inner wall of the first connecting structure, a gap is formed between the first connecting structure and the second connecting structure, and the gap is configured to be in filled with an adhesive material.

8. The lens assembly as claimed in claim 1, wherein the positioning bulge is protruded outwards from a side of the first lens near the second lens to the first limiting piece and the second limiting piece, and the positioning groove is concaved inward from the surface of the second lens near the first lens.

9. The lens assembly as claimed in claim 8, wherein the positioning bulge is contained in the positioning groove, and an end surface of the positioning bulge near the first limiting piece is located at a same height as the surface of the second lens near the first lens.

10. The lens assembly as claimed in claim 1, wherein the positioning groove is positioned between the first limiting piece and the second limiting piece, the positioning groove is concaved inward from a bottom of the receiving groove in the direction away from the second lens, the positioning bulge is protruded outward from the surface of the second lens near the first lens, and the positioning bulge abuts against a one inner wall of the positioning groove when the positioning bulge is received in the positioning groove.

11. The lens assembly as claimed in claim 3, wherein a groove depth of the positioning groove is not greater than half a thickness of the outer portion, and a width of the positioning groove is not greater than half a width of the outer portion.

12. The lens assembly as claimed in claim 3, wherein a first angle is formed between two inner walls of the positioning groove, the first angle is greater than 50°.

13. The lens assembly as claimed in claim 3, wherein an inner wall of positioning groove is a first connecting surface, an outer wall of the positioning bulge is a second connection surface, a second angle is formed between the first connecting surface and the second connecting surface, the second angle is 1° to 10°.

14. A processing method of a lens assembly, the processing method comprising:
aligning a first lens with a second lens by a positioning component;
providing a first limiting piece having a protruding distance of a first distance;
providing a second limiting piece having a protruding distance of a second distance;
arranging the first limiting piece and the second limiting piece on a side of the first lens near the second lens;
abutting the first limiting piece and the second limiting piece against the second lens, the second limiting piece is spaced from the first limiting piece;
stacking the first lens with the second lens by setting the first distance to be the same as the second distance when the side of the first lens near the second lens is parallel to a side of the second lens; and
bonding the first lens with the second lens by a connecting component.

15. The processing method as claimed in claim 14, further comprising:
making a positioning groove on the side of the first lens near the second lens;
providing the positioning component with a positioning bulge;
arranging the positioning bulge on a side of the second lens near the first lens; and
placing an end of the positioning bulge into the positioning groove of the first lens.

16. The processing method as claimed in claim 14, wherein the first lens is bonded with the second lens by the connecting component comprises:
providing a first connecting structure on the first lens;
providing a second connecting structure on the second lens;
arranging the first connecting structure at an interval with the second connecting structure to form a gap; and
filling the gap with an adhesive material.
